(19) United States
(12) Patent Application Publication
(10) Pub. No.: US 2010/0273681 A1
(43) Pub. Date: Oct. 28, 2010

(54) COMBINATORIAL CHEMISTRY REACTION CELL WITH OPTICAL TWEEZERS

(75) Inventors: Franco Cerrina, Madison, WI (US); Tao Wang, Madison, WI (US)

Correspondence Address: Bell & Manning, LLC, 122 E. Olin Avenue, Suite 290, Madison, WI, 53713, US

(73) Assignee: WISCONSIN ALUMNI RESEARCH FOUNDATION, Madison, WI (US)

(21) Appl. No.: 12/430,572

(22) Filed: Apr. 27, 2009

(51) Int. Cl. C40B 50/14; C40B 60/14

(52) U.S. Cl. 506/30; 506/40

(57) ABSTRACT

Methods for synthesizing chain molecules on particles in a multi-stream laminar flow, microfluidic reaction cells in which the methods can be carried out, and microfluidic systems incorporating the microfluidic reaction cells are provided. The methods, cells and systems are well suited for the rapid, large-scale production of chain biomolecules, such as oligonucleotides, in parallel.

### STATEMENT REGARDING FEDERALLY SPONSORED RESEARCH OR DEVELOPMENT

This invention was made with United States government support awarded by the National Institutes of Health (NIH) under grant number NIH HG003275. The United States government has certain rights in this invention.

### FIELD OF THE INVENTION

The present invention relates to methods and devices for the parallel synthesis of chain molecules, such as oligonucleotides, in a multi-stream laminar flow.

### BACKGROUND

Advances in genomics, drug discovery, microarrays and combinatorial chemistry require high-quality oligonucleotides with both high yield (percentage of correct nucleotide sequence and length) and high complexity (number of different oligonucleotides produced in one synthetic run). These requirements have led to tremendous advances in novel oligonucleotide synthesis technologies. By incorporating solid-phase chemical synthesis with semiconductor fabrication technologies, several innovations, i.e. ink-jet, electrochemical, optical and microfluidic methods, allow parallel in-situ syntheses of oligonucleotides. For example, oligonucleotides have been synthesized in systems that combine a microfluidic chip with standard solid-phase synthetic chemistry. However, these systems produce only one oligonucleotide sequence per reactor and, therefore, require complex, multi-reactor systems in order to provide for parallel synthesis of oligonucleotides.

### BRIEF SUMMARY

Methods for the parallel synthesis of chain molecules, such as oligonucleotides are provided. Also provided are microfluidic cells in which the syntheses can be carried out and microfluidic systems incorporating the microfluidic cells. The present methods, cells and systems are based on the manipulation of solid state carrier particles in a multi-stream laminar flow.

One aspect of the invention provides a method for the parallel synthesis of chain molecules on a plurality of surface-functionalized particles in a two-stream laminar flow comprising a first fluid stream and a second fluid stream. Initially, the particles are immobilized in particle holders in a first fluid stream. A first subset of these particles is moved from the particle holders in the first fluid stream to particle holders in the second fluid stream that contains a first set of reactant molecules. Surface functionalities on the particles in the second fluid stream react with the reactant molecules to form chain molecules. The first subset of particles is then moved from the particle holders in the second fluid stream back to particle holders in the first fluid stream. A second (or ‘next’) set of reactant molecules is then introduced into the second fluid stream and a second (or ‘next’) subset of the particles is moved from the particle holders in the first fluid stream to particle holders in the second fluid stream, whereby surface functionalities on the second subset of particles react with the second set of reactant molecules to continue the growth of the chain molecules.

The particles may be cycled between the first and the second fluid streams multiple times, such that the molecular chains are extended by a chain unit during each cycle. Thus, the method described above can further include the step of moving the second subset of particles from the particle holders in the second fluid stream back to particle holders in the first fluid stream, and repeating the cycle multiple times to provide chain molecules having a desired number of chain units.

In some embodiments of the present methods, the first set of reactant molecules and the subsequent sets of reactant molecules comprise different nucleotide bases and the chain molecules comprise oligonucleotides. As an example the oligonucleotide synthesis can be carried out using DMT-phosphoramidite chemistry. If DMT-phosphoramidite chemistry is used, the second fluid stream can include deblocking agents, deprotection agents, capping agents, oxidation agents, or a combination of two or more thereof, as well as oligonucleotide bases and base activating agents streamed at the opportune time. These agents can be introduced into the second fluid flows simultaneously or sequentially. The first fluid stream can comprise inert chemicals that do not participate in the synthesis. Acetonitrile is one example of an inert chemical, but other inert fluids are possible, depending on the specific chemistry being used.

In some embodiments the particles are moved between the first and second fluid flows using optical, electrical or magnetic methods. For example, the particles can be moved from particle holders in one fluid stream to particle holders in another fluid stream using optical tweezers.

Another aspect of the invention provides a microfluidic cell in which the present methods can be carried out. In some embodiments, the microfluidic cell includes a microfluidic channel comprising a first set of particle holders and a second set of particle holders, the first set running parallel to the second set along the microfluidic channel, wherein the microfluidic channel is dimensioned to support at least a two-stream laminar flow and the particle holders are dimensioned to immobilize a particle having a diameter of about 150 μm or less. In other embodiments, the particle holders may be dimensioned to immobilize larger particles including, but not limited to, particles having a diameter of 150 to 500 μm. In one embodiment of the microfluidic cell, the particle holders have an upstream opening and a downstream opening, wherein the upstream opening is larger than the downstream opening. The particle holders may have a variety of shapes, including but not limited to, V- and U-like shapes.

The microfluidic cell may further include a first inlet port in fluid communication with the microfluidic channel and configured to introduce a first laminar stream of fluid along the first set of particle holders and a second inlet port in fluid communication with the microfluidic channel and configured to introduce a second laminar stream of fluid along the second set of particles holders. In addition, the microfluidic cell may include a first outlet port in fluid communication with the microfluidic channel and configured to release the first laminar stream of fluid from the microfluidic channel and a second outlet port in fluid communication with the microfluidic channel and configured to release the second laminar stream of fluid from the microfluidic channel. More than two input connectors or channels can also be used to create multiple streams.

If the system is designed for the parallel synthesis of oligonucleotides, it may further include a source of inert reagents in fluid communication with the first inlet port and a source of nucleotide bases in fluid communication with the second inlet port.

Yet another aspect of the invention provides a microfluidic system that includes a microfluidic cell comprising a microfluidic channel comprising a first set of particle holders and a second set of particle holders, the first set running parallel to the second set along the channel, wherein the microfluidic channel is dimensioned to support a two-stream laminar flow. The microfluidic system further comprises a plurality of particles, each held in one of the particle holders and a particle trapping apparatus configured to create a trap for at least one of the particles. In one embodiment, the particle trapping apparatus comprises a laser configured to create an optical trap for at least one of the particles.

### BRIEF DESCRIPTION OF THE DRAWINGS

FIG. 1 is a schematic illustration of a method for synthesizing chain molecules in a two-stream laminar flow.

FIG. 2 is a schematic diagram of a microfluidic cell that can be used to carry out the parallel synthesis of chain molecules.

FIG. 3 shows an enlarged view of the particle holders in the microfluidic cell of FIG. 2.

FIG. 4 is a schematic diagram of a microfluidic system incorporating the microfluidic cell of FIG. 2.

FIG. 5 shows a clear field mask (a) used to make a microfluidic cell in an SU-8 photoresist layer and a dark field mask (b) used to mold a microfluidic cell in polydimethylsiloxane (PDMS) using soft lithography.

### DETAILED DESCRIPTION

A method for synthesizing chain molecules on particles in a multi-stream laminar flow is provided. Also provided are microfluidic reaction cells in which the synthesis can be carried out and microfluidic systems incorporating the microfluidic reaction cells. The methods are well suited for the rapid, large-scale production of chain biomolecules, such as oligonucleotides.

The present methods are carried out using a multi-stream laminar flow that includes at least a first fluid stream and a second fluid stream. Surface-functionalized particles are moved from one stream to another in the laminar flow using, for example, optical tweezers. By exposing different subsets of the particles to different reactants or reagents in the various streams of the laminar flow in a step-wise fashion, a large number of chain molecules having different molecular sequences can be fabricated in parallel.

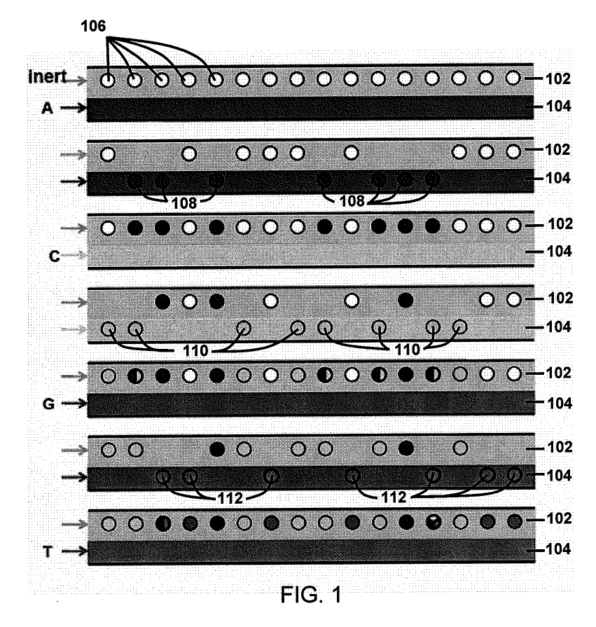

A method of fabricating chain molecules in a two-stream laminar flow is illustrated schematically in FIG. 1. The laminar flow includes a first fluid stream 102 and a second fluid stream 104. For purposes of illustration, FIG. 1 depicts the formation of an oligonucleotide from nucleotide bases. However, other types of chain molecules could be fabricated using the same principal of operation.

Oligonucleotides may be synthesized one base at a time using a solid-phase support DMT-phosphoramidite chemistry reaction scheme. In this reaction scheme, a base is affixed to a particle via its 3′-phosphate group and individual nucleotide bases are added sequentially to the chain growing in the 3′-5′ direction. Briefly, the reaction scheme includes four basic steps: (1) deblocking (detritylation); (2) coupling; (3) capping; and (4) oxidation.

In the deblocking step, the dimethoxytrityl (DMT) group is removed from a DMT-protected base with an acid, such as trichloroacetic acid (TCA). In the present methods, this deblocking step can take place for DMT-protected bases immobilized on particles in the second fluid stream. Thus, a subset of the particles can then be moved from the first fluid stream containing inert reagents to the second fluid stream where base coupling is carried out. In the coupling step, the diisopropylamino (iPr2N) groups of phosphoramidite nucleotides in the second fluid stream are removed by activating agents (e.g., tetrazole) in the second fluid stream, the phosphates on the activated nucleotide bases then react with the deblocked bases on the particles to join the two bases via phosphate linkages. Capping agents can then be introduced into the second fluid stream so that unreacted 5′ OH groups on the nucleotide bases are capped using, for example, acetic anhydride or 1-methylimidazole. Finally, the phosphate linkages can be stabilized by oxidizing the phosphite groups into phosphate groups. This can be achieved by flowing iodine and water in the second fluid stream. Each of the steps in the synthesis can be conducted via the sequential introduction of the appropriate reagents into the appropriate fluid stream in a suitable carrier or solvent. Washing steps may be included between the steps described above by introducing washing agents into the appropriate fluid stream. Once the oligonucleotides have been synthesized, they can be deprotected and cleaved from the particles via base hydrolysis. (Although the method has been described for an embodiment, wherein all of the chain synthesis steps take place in the second fluid stream, it should be understood that, in other embodiments, the synthesis steps may be divided between two or more fluid streams.)

Initially, as shown in panel (a), a plurality of surface-functionalized particles 106 are immobilized in the first fluid stream. A subset 108 of the particles is moved to the second fluid stream where surface functionalities on the particles react with reactant molecules to form chain molecules on the particles, as shown in panel (b). In the present examples the reactant molecules are phosphoramidite adenine (A) bases. The particles in the subset are then returned to the first fluid stream (panel (c)). Another set of reactant molecules (i.e., a ‘next set’) is then introduced into the second fluid stream. In the present example this next set of molecules comprises phosphoramidite cytosine (C) bases. Another subset of particles 110 (i.e., a ‘next subset’) is then moved to the second fluid stream where surface functionalities on the particles react with the phosphoramidite-C bases to continue the growth of oligonucleotides on the particles (panel (d)). (As used herein, the phrase “surface functionalities” includes both reactive atoms or functional groups that are initially present on the particles and functionalities on the chain molecules that are subsequently grown on the surface of the particles. Thus, in the present example, the A bases on the particles can serve as “surface functionalities” for the C bases.) This subset of particles 110 is subsequently returned to the first fluid stream (panel (e)). A third set of reactant molecules (i.e., a ‘next set’) comprising guanine (G) bases is then introduced into the second fluid stream and a third subset 112 (i.e., a ‘next subset’) of particles is moved into that stream where surface functionalities on the particles (e.g., A bases, C bases or functionalities initially present on the surfaces of the particles) react with the G bases (panel (f)). The third subset of particles 112 is then returned to the first fluid stream (panel (g)). The process can be repeated using, for example, a fourth set of reactant molecules comprising thymine (T) bases in the second fluid stream.

The sequence of steps illustrated in FIG. 1 can be repeated multiple times using different subsets of particles and different reactant molecules to provide chain molecules having desired sequences and lengths. For example, the method may be used to synthesize oligonucleotides comprising at least 10 nucleotide bases. This includes embodiments wherein the oligonucleotides comprising 100 nucleotide bases or more. The number of different chain molecule sequences produced in parallel by the present methods will depend on the number of particles and the number of chain extension steps in the synthesis. In some embodiments, the present methods can be used to synthesize 10 or more, 100 or more, or 1,000 or more different oligonucleotides in parallel.

By replacing the reagents and reactants in the example described above, chain molecules other than DNA can be synthesized using the present methods. These include, but are not limited to, RNA, polypeptides and polysaccharides.

Variations on the sequence of synthesis steps depicted in FIG. 1 are possible. For example, each subset of particles can be the same as, or different from, one or more of the preceding subsets of particles. However, generally, at least two of the particle subsets in a sequence of synthesis steps will differ. Similarly, each set of reactant molecules can be the same as, or different from, one or more of the preceding sets of reactant molecules. Although, typically, at least two sets of reactant molecules in a sequence of synthesis steps will differ. In some embodiments at least one fluid stream in the laminar flow will include reactant molecules that react with surface-functionalities on the particles to grow the chain molecules (i.e., a “reactive” stream), and at least one fluid stream will be free of such reactant molecules (i.e., an “inert” stream). The two streams may alternate roles, as needed by the particular nature of the synthesis process. In addition, although FIG. 1 shows all of the particles in a given subset being moved from the first fluid stream to the second fluid stream and then back, in some variations of the methods, only some of the particles in a given subset will be moved back to the first fluid stream prior to the introduction of the next set of reactant molecules into the second fluid stream.

Although the multi-stream laminar flow used to synthesize chain molecules in parallel will include at least a two-stream laminar flow, as illustrated in FIG. 1, a greater number of fluid streams (e.g., at least 3, at least 4, at least 5, at least 10, etc.) may also be employed. For example, in some embodiments the multi-stream laminar flow may comprise a three-stream laminar flow comprising an inert fluid stream disposed between two reactive fluid streams. In some embodiments the multi-stream laminar flow may comprise a three-stream laminar flow comprising a reactive fluid stream disposed between two inert fluid streams. In some embodiments the multi-stream laminar flow may comprise adjacent reactive fluid streams and/or adjacent inert fluid streams. In these embodiments surface-functionalized particles can be moved independently between the various fluid streams in order to synthesize a wide variety of chain molecules.

The present methods for the parallel synthesis of chain molecules may be carried out in a microfluidic reaction cell. In general, such a cell will include a microfluidic channel that is dimensioned to contain at least two sets of particles and to support a two-stream laminar flow, and configured to direct one fluid stream of the laminar flow over the first set of particles and the second stream of the laminar flow over the second set. Particle holders in the microfluidic channel can be designed to immobilize the particles within the laminar flow while the microfluidic cell is in operation. Generally, the flow through the microfluidic channel is laminar at Reynolds numbers (Rₑ) <2200, where Rₑ=(Lνρ)/η and L is the channel height, ν is the fluid velocity, ρ is the fluid density and η is the fluid viscosity. However, in the present cells Rₑ can be <10, and is desirably <1 so that the flow is laminar in nature.

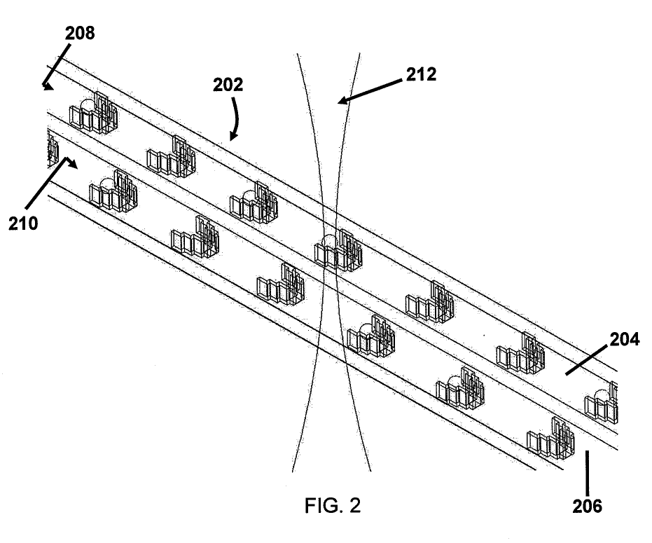

An embodiment of a microfluidic cell that can be used to carry out a parallel synthesis of chain molecules is shown schematically in FIG. 2. The microfluidic cell of this embodiment includes a microfluidic channel 202 dimensioned to support a two-stream laminar flow that includes a first fluid stream 204 and a second fluid stream 206. The microfluidic channel includes a first set of particles holders 208 and a second set of particle holders 210 running parallel along the microfluidic channel. The first and second sets of particle holders are configured such that the first fluid stream will be directed over the first set and the second fluid stream will be directed over the second set when the cell is in operation. Also shown is a laser beam 212 that can be used to trap and move particles from one fluid stream to another. (See further discussion below.)

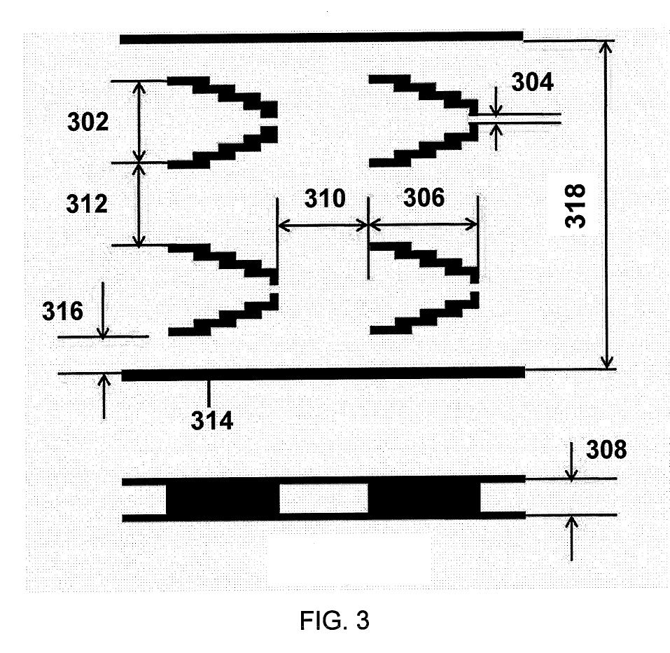

As shown in FIG. 3, the particle holders in this example are trapezoidal in shape, having an upstream opening and a downstream opening, such that a particle contained within a particle holder will be immobilized as a fluid stream passes over the particle, and over and through the particle holder when the microfluidic cell is in operation. Other shapes for the particle holders are also possible, provided the shapes enable the particles to be immobilized in a laminar fluid flow and readily moved from a particle holder in one stream to a particle holder in another stream while the cell is in operation. For example, other suitable particle holder shapes include, but are not limited to, semicircles and U-shapes. Regardless of the shape, the particle holders desirably include a downstream opening that allows a fluid stream to pass through the holders.

The dimensions and spacing of the particle holders will depend on the number and size of the particles to be immobilized. In some embodiments, the particle holders will have a height of no greater than about 150 μm. This includes embodiments in which the particle holders have a height of no greater than about 100 μm, and further includes embodiments in which the particle holders have a height of no greater than about 50 μm. In some embodiments the diameter of the upstream opening of the particle holders will be no greater than about 150 μm. This includes embodiments in which the diameter of the upstream opening is no greater than about 100 μm, and further includes embodiments in which the diameter of the upstream opening is no greater than about 50 μm.

The actual dimensions of the microfluidic channel will depend, in part, on such factors as the shape of the channel, the dimensions of the beads to be used, the number of beads to be used, the viscosity, density and velocity of the fluid streams in the laminar flow, and the number of fluid streams in the laminar flow. In addition, the selection of each channel dimension (e.g., width, height, length) may be closely tied to the selection of the other dimensions.

The microfluidic channel should have a channel length that is sufficient to accommodate the number of particles upon which the chain molecules are to be synthesized. In some embodiments the microfluidic channel will have a length of at least 1 cm. This includes embodiments where the channel length is at least 5 cm and further includes embodiments where the channel length is at least 10 cm.

The microfluidic channel should have a channel height that is sufficient to accommodate the particles upon which the chain molecules are to be synthesized. For example, the microfluidic channel may have a channel height that is no greater than about twice the height of the particles. In some embodiments the microfluidic channel will have a channel height of no greater than about 200 μm. This includes embodiments in which the channel height is no greater than about 150 μm and further includes embodiments in which the channel height is no greater than about 100 μm.

The microfluidic channel should have a width that is sufficient to support at least a two-stream laminar flow without significant mixing. Thus, the appropriate width will depend on the number of fluid streams in the flow and the length of the channel. In some embodiments the microfluidic channel will have a channel width of at least 500 μm. In some embodiments the microfluidic channel will have a channel width no greater than about 1 cm.

Variations on the structure of the microfluidic channel depicted in FIG. 2 are possible. For example, although the microfluidic channel will include at least two sets of particle holders, as illustrated in FIG. 2, a greater number of sets (e.g., at least 3, at least 4, at least 5, at least 10, etc.) may also be employed. In addition, the particle holders in each set do not have to be placed directly laterally across from one another, as depicted in FIG. 2. Rather, the particle holders in a given set may have a longitudinally staggered arrangement with respect to the particle holders in other sets. Similarly, the particle holders in a given set do not have to be aligned along a common longitudinal axis within that set, as depicted in FIG. 2. Thus, the phrase “a set of particle holders” includes a line of particle holders in which at least some of the particle holders are laterally offset with respect to a central longitudinal axis and with respect to other particle holders in that line. The demarcation between sets of particle holder can be defined by a longitudinal axis that runs between two lines of particles holders, without intersecting any particle holders in those lines, or, if the microfluidic cell is in operation, a set of particle holders can be defined as those particle holders contained within a given fluid stream.

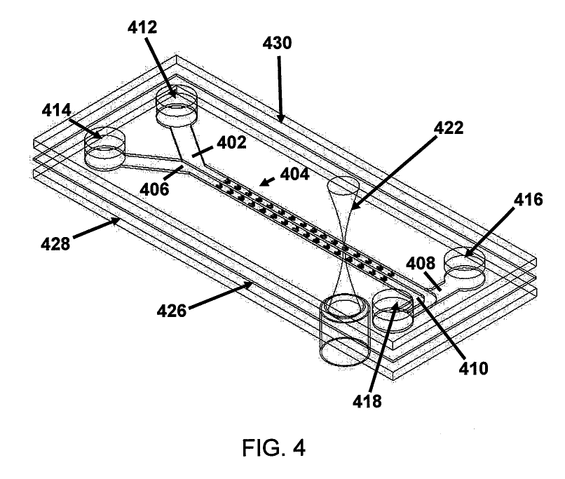

FIG. 4 is a schematic diagram of a microfluidic cell incorporating the microfluidic channel of FIG. 2. In addition to the microfluidic channel 404, this reaction cell includes a first inlet port 402 in fluid communication with the microfluidic channel 404 and configured to introduce a first laminar fluid stream along the first set of particle holders, and a second inlet port 406 in fluid communication with the microfluidic channel 404 and configured to introduce a second laminar fluid stream along the second set of particle holders. The microfluidic cell further includes a first outlet port 408 in fluid communication with the microfluidic channel and configured to release the first laminar fluid stream from the microfluidic cell, and a second outlet port 410 in fluid communication with the microfluidic channel and configured to release the second laminar fluid stream from the microfluidic cell. In addition, the reaction cell includes a first reagent source 412 in fluid communication with the first inlet port 402, a second reagent source 414 in fluid communication with the second inlet port 406, a first reagent collection reservoir 416 in fluid communication with the first outlet port, and a second reagent collection reservoir 418 in fluid communication with the second outlet port. In variations on the microfluidic cell depicted in FIG. 4, one or more of the inlet ports and outlet ports may be in fluid communication with two or more reagent sources or reagent reservoirs, respectively.

The flow of the various reagents into and out of the microfluidic channel can be controlled using conventional components, such as valves, pumps and the like, external to the microfluidic device, or integrated in it. The flow of the reagents may be carried out manually or with the aid of a controller. For example, a controller may be connected to the reagent sources to provide reagents to the microfluidic channel in a selected sequence. The controller can also connected to controllable valves which are connected to the output ports. It is desirable that the controller be an automated controller, such as a computer-controlled controller.

The microfluidic cells can be made using conventional lithographic processing techniques on a variety of substrates. For example, a microfluidic cell can be made using maskless lithography by patterning a photoresist layer (e.g., SU-8) 426 on a rigid substrate (e.g., glass or a silicon wafer) 428. The pattern may be generated, for example, using a digital micromirror array. In some embodiments, the patterned photoresist layer may be incorporated into the reaction cell. In other embodiments, the patterned photoresist layer may be used as a master mold to replicate the reaction cell pattern in another material, such as PDMS. Once the microfluidic cell has been patterned and etched or molded, a top plate 430 may be disposed over the top of the etched or molded layer to provide an enclosed cell. Electrically conducting features, such as metal contacts, electrodes and heaters, can be fabricated on the cell using metal (e.g., Cr) lift-off techniques. A more detailed description of a method for forming a microfluidic cell is provided in the Example below.

The reaction cell of FIG. 4 is part of a larger microfluidic system that also includes a plurality of particles immobilized in the particle holders and a particle trapping apparatus configured to create a trap 422 for at least one of the particles.

The particles are desirably porous, such that they have a large surface area, and include surface functionalities that enable them to act as carrier particles on which chain molecules can be synthesized. In some embodiments, the surfaces of the carrier particles are coated with a material that provides a surface functionality that acts as a linker between the surface of the particle and the chain molecule to be formed. The particles may have diameters of from a few pm (e.g., 5 μm) to a hundred μm or more (e.g., up to 150 μm or greater). The particles may be spherical, or substantially spherical, but can also be formed in shapes other than spheres, for example, cylinders, fibers, or irregular shapes, with smooth or structured surfaces. The particles may be formed of a variety of materials, including silica, quartz, polystyrene, controlled porosity glass (CPG) or similar porous materials which provide a large surface area to mass ratio.

The particle trapping apparatus can be an apparatus that is capable of subjecting a particle to an electric and/or magnetic field, such that the particle is immobilized by the field. A trapped particle can be moved from one location to another within a microfluidic channel by moving the trap relative to the microfluidic channel. This relative motion can be accomplished by moving the microfluidic cell, moving the trap, or moving both. For example, a particle in a first fluid stream can be moved to a second fluid stream by trapping the particle in a particle holder in the first fluid stream, moving the trapped to a particle holder in the second fluid stream, and releasing the particle by removing or eliminating the trap.

In some embodiments of the microfluidic systems, the particle trapping apparatus comprises a laser which creates an optical trap (e.g., optical tweezers) for moving a dielectric particle. A description of an apparatus for producing optical tweezers can be found in U.S. Pat. No. 6,055,106; Ashkin et al., Optics Letters, 11(5), 288-290 (1986); and Grier, D. G., Nature, 424(6950), 810-816 (2003). In embodiments where the particles comprise a magnetic material, the particle trapping apparatus can comprise a magnet which creates a magnetic trap for moving a particle. The microfluidic system may be configured to include only a single particle trap, such that the particles are moved sequentially from particle holder to particle holder during the synthesis of chain molecules. Alternatively, the microfluidic system may be configured to include multiple particle traps (generated by one or more particle trapping apparatus), such that more than one particle can be moved simultaneously from one particle holder to another.

The optimal laminar fluid flow speed in the microfluidic system will depend on a variety of factors, including the size of the particles, the composition of the fluid streams, and nature of the particle trap. By way of illustration only, CPG particles having diameters of about 2 to about 20 μm and 15 nm pores can be trapped and manipulated using a Arryx BioRyx holographic optical trapping laser at powers from about 0.2 W to about 20 W in an acetonitrile laminar flow at a flow rate of about 0.4 to 0.5 μL/s.

### EXAMPLE

This Example illustrates a method of forming a microfluidic cell using maskless lithography. Microfluidic cells were fabricated from a patterned SU-8 photoresist layer and from a molded PDMS layer.

A 4″-inch silicon wafer was used as the substrate for the microfluidic cells. The wafer was cleaned and dehydrated in oven at 125° C. for 30 min. A layer of SU-8 photoresist was spun onto the silicon wafer as follows: The SU-8 was spun on the wafer at 500 rpm for 5 seconds and the spin rate was then raised to 3000 rpm for 30 seconds to achieve the desired thickness of 60 μm. The wafer was then soft baked on a hot plate at 65° C. for 2 minutes and then on another hot plate at 95° C. for 6 minutes.

The maskless fabricated SU-8 layer was used as a master for replicating a molded PDMS layer. The master was first treated with a release agent (316 Silicone Release Spray, Dow Corning) to help the PDMS release after the molding. A mixed PDMS prepolymer (Sylgard 184: cure agent at 10:1 by weight, Dow Corning) was cast onto the master followed by degassing in a vacuum chamber to remove trapped air bubbles. The PDMS prepolymer was cured at 75-80° C. for several hours on a hot plate. After curing, the PDMS layer was carefully peeled off the SU-8 master. The PDMS layer can be readily bonded to glass or another PDMS layer after treatment with oxygen plasma.

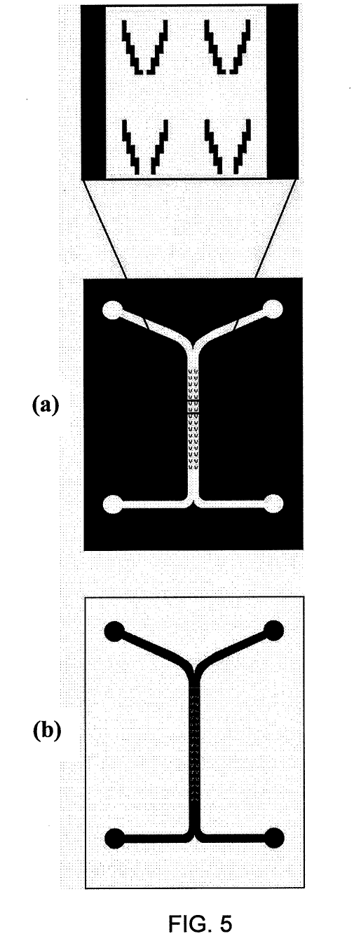

Both SU-8 and PDMS layers were fabricated from digital masks shown in FIG. 5(a) (SU-8 mask) and 5(b) (PDMS mask) using maskless lithography. (Although maskless lithography is used in this example, other lithographic techniques can be employed.) The masks were designed in two tones in a bitmap (BMP) format. The dark-field mask (panel (b)) was used to form a microfluidic channel in the PDMS layer via soft lithography, and the clear-field mask (panel (a)) was used to form a microfluidic channel in the SU-8 layer. The overall size was 1024×768 pixels—equivalent to 1.4×1.1 cm². The 60-μm channel layer includes two entrances at the Y-shaped end, two exits at the T-shaped end and one 550 μm wide reaction channel in between. Sixteen pairs of anchors were arranged in the microfluidic channel.

A section of the resulting microfluidic channel is shown in FIG. 3. The dimensions and spacing of the particle holders 300 in the microfluidic channel section of FIG. 3 are as follows: upstream opening diameter≈120 μm (302); downstream opening diameter≈10-40 μm (304); particle holder length≈150 μm (306); particle holder height≈40-70 μm (308); lateral spacing between particle holders≈120 μm (310); longitudinal spacing between particle holders≈120 μm (312); and spacing between the wall 314 of the microfluidic channel and the particle holders≈70 μm (316). In this example, the diameter of the microfluidic channel is about 550 μm (318). This microfluidic channel is adapted to hold particles having a diameter of about 20-45 μm at a particle-to-particle spacing of about 270 μm.

For the purposes of this disclosure, and unless otherwise specified, “a” or “an” means “one or more.” All patents, applications, references and publications cited herein are incorporated by reference in their entirety to the same extent as if they were individually incorporated by reference.

It is understood that the invention is not limited to the embodiments set forth herein for illustration, but embraces all such forms thereof as come within the scope of the following claims.

We claim:

1. A method for the parallel synthesis of chain molecules on a plurality of surface-functionalized particles in a multi-stream laminar flow comprising a first fluid stream and a second fluid stream, the method comprising:
(a) providing a first set of reactant molecules in the second fluid stream;
(b) moving a first subset of the particles from particle holders in the first fluid stream to particle holders in the second fluid stream, whereby surface functionalities on the particles react with the first set of reactant molecules to form chain molecules;
(c) moving the first subset of the particles from the particle holders in the second fluid stream back to particle holders in the first fluid stream;
(d) providing a next set of reactant molecules in the second fluid stream; and
(e) moving a next subset of the particles from particle holders in the first fluid stream to particle holders in the second fluid stream, whereby surface functionalities on the particles react with the next set of reactant molecules to form chain molecules.

2. The method of claim 1, wherein the first set of reactant molecules and next set of reactant molecules comprises different nucleotide bases and the chain molecules comprise oligonucleotides.

3. The method of claim 2, wherein the second fluid stream further comprises nucleotide base coupling reagents, deprotection reagents, deblocking agents, capping agents, oxidation agents, or a mixture thereof.

4. The method of claim 2, further comprising:
(f) moving the next subset of particles from particle holders in the second fluid stream back to particle holders in the first fluid stream; and
repeating steps (d) through (f) multiple times to provide oligonucleotides comprising at least 100 nucleotide bases.

5. The method of claim 1, wherein the plurality of particles comprises at least 10 particles.

6. The method of claim 1, wherein moving the particles from particle holders in one fluid stream to particle holders in the other fluid stream comprises moving the particles using optical tweezers.

7. The method of claim 4, wherein moving the particles from particle holders in one fluid stream to particle holders in the other fluid stream comprises moving the particles using optical tweezers.

8. A microfluidic cell comprising a microfluidic channel comprising a first set of particle holders and a second set of particle holders, the first set running parallel to the second set along the microfluidic channel, wherein the microfluidic channel is dimensioned to support a two-stream laminar flow and the particle holders are dimensioned to immobilize a particle having a diameter of about 150 μm or less.

9. The microfluidic cell of claim 8, wherein the microfluidic channel has a height no greater than about 200 μm and a width no greater than about 1 cm.

10. The microfluidic cell of claim 9, wherein the particle holders have an upstream opening and a downstream opening, wherein the upstream opening is larger than the downstream opening.

11. The microfluidic cell of claim 10, wherein the upstream openings of the particle holders have a diameter of no greater than about 150 μm.

12. The microfluidic cell of claim 11, wherein in the particle holders have a height of no greater than about 100 μm.

13. The microfluidic cell of claim 8, further comprising a first inlet port in fluid communication with the microfluidic channel and configured to introduce a first laminar stream of fluid along the first set of particle holders and a second inlet port in fluid communication with the microfluidic channel and configured to introduce a second laminar stream of fluid along the second set of particles holders.

14. The microfluidic cell of claim 13, further comprising a first outlet port in fluid communication with the microfluidic channel and configured to release the first laminar stream of fluid from the microfluidic channel and a second outlet port in fluid communication with the microfluidic channel and configured to release the second laminar stream of fluid from the microfluidic channel.

15. The microfluidic cell of claim 8, wherein the first set of particle holders and the second set of particles holders each comprise at least 10 particle holders.

16. The microfluidic cell of claim 15, wherein each particle holder in the first set corresponds to a particle holder in the second set.

17. A microfluidic system comprising:
(a) a microfluidic cell comprising a microfluidic channel comprising a first set of particle holders and a second set of particle holders, wherein the microfluidic channel is dimensioned to support a two-stream laminar flow;
(b) a plurality of particles, each held in one of the particle holders; and
(c) a particle trapping apparatus configured to create a trap for at least one of the particles.

18. The microfluidic system of claim 17, wherein the particle trapping apparatus comprises a laser configured to create an optical trap for at least one of the particles.

19. The microfluidic system of claim 17, wherein the microfluidic cell further comprises a first inlet port in fluid communication with the microfluidic channel and configured to introduce a first laminar stream of fluid along the first set of particle holders and a second inlet port in fluid communication with the microfluidic channel and configured to introduce a second laminar stream of fluid along the second set of particles holders.

20. The microfluidic system of claim 19, further comprising a source of inert reagents in fluid communication with the first inlet port and a source of nucleotide bases in fluid communication with the second inlet port.
